(19) United States
(12) Patent Application Publication
(10) Pub. No.: US 2025/0088259 A1
(43) Pub. Date: Mar. 13, 2025

(54) COMMUNICATION METHOD, DEVICE AND SYSTEM

(71) Applicant: FUJITSU LIMITED, Kawasaki-shi (JP)

(72) Inventors: Qinyan JIANG, Beijing (CN); Lei ZHANG, Beijing (CN)

(73) Assignee: FUJITSU LIMITED, Kawasaki-shi (JP)

(21) Appl. No.: 18/954,672

(22) Filed: Nov. 21, 2024

Related U.S. Application Data
(63) Continuation of application No. PCT/CN2022/097239, filed on Jun. 6, 2022.

(51) Int. Cl. H04B 7/155; H04W 16/28

(52) U.S. Cl. CPC H04B 7/15542; H04W 16/28

(57) ABSTRACT

A communication device includes: a first module of a repeater acquires a first beam indication, the first beam indication being at least used by the first module to receive a signal from a first network device at a first band, and/or the first module of the repeater acquires a second beam indication, the second beam indication being at least used by the first module to transmit a signal to the first network device at the first band.

### CROSS-REFERENCE TO RELATED APPLICATION

This application is a continuation application of International Application PCT/CN2022/097239 filed on Jun. 6, 2022, and designated the U.S., the entire contents of which are incorporated herein by reference.

### TECHNICAL FIELD

The present disclosure relates to the field of communications.

### BACKGROUND

Compared with traditional 2G (second generation mobile communication technology), traditional 3G (third generation mobile communication technology) and 4G (fourth generation mobile communication technology) systems, a 5G (fifth generation mobile communication technology) system is capable of providing a greater bandwidth and a higher data rate, and is capable of supporting more types of terminals and vertical services. To this end, band ranges/operating bandwidths supported by the 5G system are obviously greater than those supported by 2G, 3G and 4G systems, and the 5G system supports a higher carrier frequency. For example, the 5G system may be deployed at a millimeter wave band.

However, the higher a carrier frequency, the more severe the fading that a signal experiences during transmission. Therefore, in actual deployment of the 5G system, especially at a millimeter wave band, how to better enhance cell coverage becomes an urgent problem to be solved.

In order to better solve the coverage problem of a cellular mobile communication system in actual deployment, an RF repeater (an RF relay/repeater) is adopted to amplify and forward a signal between devices, which is a more commonly used deployment means. An RF repeater is widely applied in actual deployment of 2G, 3G and 4G systems, its advantages lie in low cost, easy to deploy, and not add too much delay. Generally speaking, the RF repeater is a device that amplifies and forwards incoming and outgoing signals between devices in an RF domain. That is to say, the RF repeater is a non-regenerative relay node that just amplifies and forwards all received signals directly.

In addition, traditional RF repeaters do not have a communication function. That is to say, traditional RF repeaters cannot perform information interaction with other devices (such as a base station/terminal equipment, etc.). Specifically, in terms of reception, traditional RF repeaters do not support measurement/demodulation/decoding, etc. of a received signal. In terms of transmission, traditional RF repeaters only amplify and forward a received RF signal, and do not support generation of a signal and transmission of a signal generated by themselves.

Therefore, an operation-related configuration (e.g., an antenna direction (beam direction and/or width (or size)), a forwarding direction, a switch state, an amplification gain, etc.) of traditional RF repeaters is not controlled by a network and is usually set or adjusted manually. For example, an antenna direction is usually set and adjusted manually at the time of initial installation, so that an antenna at a base station side points to a direction of incoming wave from the base station, and an antenna at a terminal side points to an area where the deployment needs to be enhanced.

It should be noted that the above introduction to the technical background is just to facilitate a clear and complete description of the technical solutions of the present disclosure, and is elaborated to facilitate the understanding of persons skilled in the art. It cannot be considered that the above technical solutions are known by persons skilled in the art just because these solutions are elaborated in the Background of the present disclosure.

### SUMMARY

The inventor finds that for the coverage problem encountered in the deployment of the 5G system, adopting a traditional RF repeater to perform coverage enhancement is one of the feasible solutions. However, since an operation-related configuration (e.g., an antenna direction (beam direction and/or width (or size)), a forwarding direction, a switch state, an amplification gain, etc.) of traditional RF repeaters is not controlled by a network, on the one hand, an effect of amplifying and forwarding a target signal may not be ideal; on the other hand, it may cause obvious interference to other devices in the network, increasing a noise and interference level of the system, thereby reducing a network throughput.

By taking the antenna direction as an example, compared to 2G, 3G and 4G systems, the 5G system employs a more advanced and complex MIMO (Multiple Input Multiple Output) technology. In the 5G system, in particular for a higher carrier frequency, a directed antenna becomes a basic component of a base station and a terminal equipment, transmitting and receiving a signal based on the beam forming technology is a basic signal transmission mode in the 5G system. An (analog) beam direction, width (size), etc. of the base station and the terminal equipment may be dynamically changed due to factors such as a position change (that is, beam switching). However, for an antenna of a traditional RF repeater, its direction cannot be adjusted dynamically, its beam width is wider, and a beam direction and a beam width of its transceiving antenna cannot flexibly match a position of the base station and of the terminal equipment, as well as a dynamic change of the beam direction and width of the transceiving antenna.

FIG. 1 is an example of a transceiving antenna of an RF repeater deployed in a 5G system, as shown in FIG. 1, such a RF repeater is configured in the 5G system, on the one hand, its performance/effect of amplifying/enhancing a target signal may not be significant due to mismatch between a beam direction and a beam width of its transceiving antenna and a dynamic change of a beam direction and width of a transceiving antenna of the base station and of the terminal equipment, on the other hand, it may also cause obvious interference to other devices (such as a base station or terminal equipment) within a larger range due to use of a wider transmitting beam, increasing a noise and interference level of the whole system, thereby reducing a network throughput.

In order to solve at least one of said problems, the network (base station) is capable of performing some control to the operation-related configuration of the RF repeater. In order to achieve the control by the network to the operation-related configuration of the RF repeater, it is necessary to support information interaction between the network (base station) and the RF repeater, so that the RF repeater may, according to an indication of the network (base station), set and/or adjust the operation-related configuration such as an antenna direction (beam direction and/or width (or size)), a forwarding direction, a switch state and an amplification gain, etc. That is, the RF repeater has a function of communication to receive (demodulate/measure/decode/interpret, etc.) information transmitted by the network (base station), and/or to transmit information to the network (base station).

However, currently, there is no specific method for how to support the above information interaction and how the RF repeater works in the case of supporting the above information interaction.

For the above problems, embodiments of the present disclosure provide a communication method, device and system to support information interaction between a network device (base station) and a RF repeater, so that the RF repeater works in the case of supporting the above information interaction.

Embodiments of the present disclosure relate to beam indication in the case of supporting information interaction between the RF repeater and a network.

According to an aspect of the embodiments of the present disclosure, a communication device is provided, configured in a repeater, the device includes a first module and a second module, wherein
the first module acquires a first beam indication, the first beam indication being at least used by the first module to receive a signal from a first network device at a first band, and/or the first module of the repeater acquires a second beam indication, the second beam indication being at least used by the first module to transmit a signal to the first network device at the first band,
and the first module acquires a third beam indication, the third beam indication being at least used by the second module of the repeater to receive a third signal from a second network device at a second band, the third signal being used to be forwarded, and/or, the first module acquires a fourth beam indication, the fourth beam indication being at least used by the second module to forward a processed fourth signal from a terminal equipment to the second network device at the second band, and
the first band and the second band do not overlap in a frequency domain.

One of advantageous effects of the embodiments of the present disclosure lies in: according to the embodiments of the present disclosure, by obtaining a first beam indication and/or a second beam indication, communication (information interaction) between a repeater and a base station (a first network device) may be achieved. In addition, by obtaining a third beam indication and/or a fourth beam indication, forwarding of a signal between a base station (a second network device) and a terminal equipment by the repeater may be achieved.

Referring to the later description and drawings, specific implementations of the present disclosure are disclosed in detail, indicating a manner that the principle of the present disclosure may be adopted. It should be understood that the implementations of the present disclosure are not limited in terms of the scope. Within the scope of the terms of the appended claims, the implementations of the present disclosure include many changes, modifications and equivalents.

Features that are described and/or illustrated with respect to one implementation may be used in the same way or in a similar way in one or more other implementations and in combination with or instead of the features in the other implementations.

### BRIEF DESCRIPTION OF DRAWINGS

An element and a feature described in a drawing or an implementation of the embodiments of the present disclosure may be combined with an element and a feature shown in one or more other drawings or implementations. In addition, in the drawings, similar labels represent corresponding components in several drawings and may be used to indicate corresponding components used in more than one implementation.

The included drawings are used to provide a further understanding on the embodiments of the present disclosure, constitute a part of the Specification, are used to illustrate the implementations of the present disclosure, and expound the principle of the present disclosure together with the text description. Obviously, the drawings in the following description are only some embodiments of the present disclosure. Persons skilled in the art may further obtain other drawings based on these drawings under the premise that they do not pay inventive labor. In the drawings:

FIG. 1 is a schematic diagram of an example of a transceiving antenna of an RF repeater deployed in a 5G system;

FIG. 2 is a schematic diagram of an example of a NCR;

FIG. 3 is a schematic diagram of an example of an implementation scenario in the embodiments of the present disclosure;

FIG. 4 is a schematic diagram of a relation between a link and a frequency range of a NCR.

FIG. 5 is a schematic diagram of a communication method in the embodiments of the present disclosure;

FIG. 6 is a schematic diagram of a network architecture corresponding to the method in FIG. 5;

FIG. 7 is another schematic diagram of a network architecture corresponding to the method in FIG. 5;

FIG. 8 is a schematic diagram of an instance of a relation between a frequency range (FR) and a band within the FR in a frequency domain;

FIG. 9 is a schematic diagram of an instance of a relation between a band and a carrier in the band in a frequency domain;

FIG. 10 is a schematic diagram of first to sixth beams;

FIG. 11 is another schematic diagram of first to sixth beams;

FIG. 12 is a further schematic diagram of first to sixth beams;

FIG. 13 is a further schematic diagram of first to sixth beams;

FIG. 14 is a schematic diagram of an example in which a repeater receives a signal according to a method in the embodiments of the present disclosure;

FIG. 15 is a schematic diagram of another example in which a repeater receives a signal according to a method in the embodiments of the present disclosure;

FIG. 16 is a schematic diagram of an example in which a repeater transmits a signal according to a method in the embodiments of the present disclosure;

FIG. 17 is a schematic diagram of another example in which a repeater transmits a signal according to a method in the embodiments of the present disclosure;

FIG. 18 is a schematic diagram of an example in which a repeater forwards a signal according to a method in the embodiments of the present disclosure;

FIG. 19 is a schematic diagram of a communication device in the embodiments of the present disclosure;

FIG. 20 is a schematic diagram of a repeater in the embodiments of the present disclosure;

FIG. 21 is a schematic diagram of a network device in the embodiments of the present disclosure.

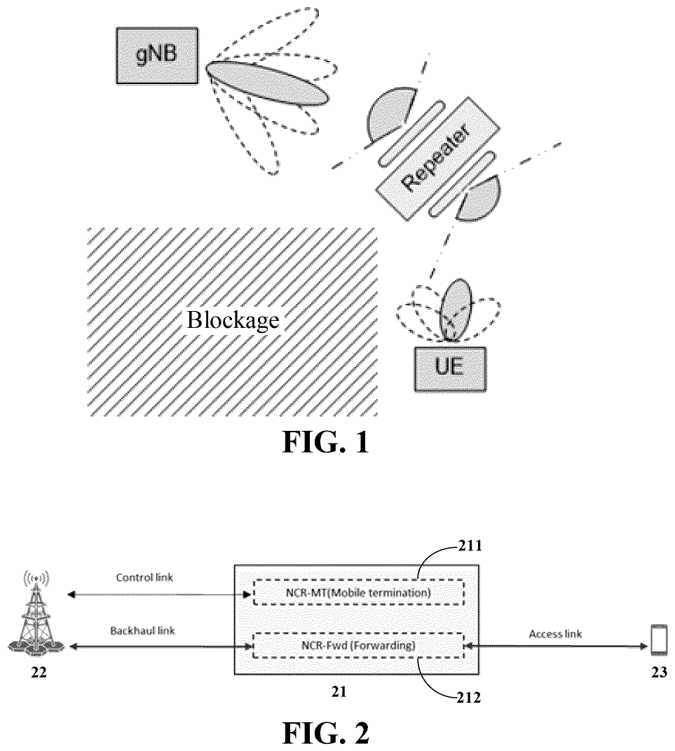

### DETAILED DESCRIPTION

Referring to the drawings, through the following Specification, the aforementioned and other features of the present disclosure will become obvious. The Specification and the drawings specifically disclose particular implementations of the present disclosure, showing partial implementations which may adopt the principle of the present disclosure. It should be understood that the present disclosure is not limited to the described implementations, on the contrary, the present disclosure includes all the modifications, variations and equivalents falling within the scope of the attached claims.

In the embodiments of the present disclosure, the term “first” and “second”, etc. are used to distinguish different elements in terms of appellation, but do not represent a spatial arrangement or time sequence, etc. of these elements, and these elements should not be limited by these terms. The term “and/or” includes any and all combinations of one or more of the associated listed terms. The terms “include”, “comprise” and “have”, etc. refer to the presence of stated features, elements, members or components, but do not preclude the presence or addition of one or more other features, elements, members or components.

In the embodiments of the present disclosure, the singular forms “a/an” and “the”, etc. include plural forms, and should be understood broadly as “a kind of” or “a type of”, but are not defined as the meaning of “one”; in addition, the term “the” should be understood to include both the singular forms and the plural forms, unless the context clearly indicates otherwise. In addition, the term “according to” should be understood as “at least partially according to . . . ”, the term “based on” should be understood as “at least partially based on . . . ”, unless the context clearly indicates otherwise.

In the embodiments of the present disclosure, the term “a communication network” or “a wireless communication network” may refer to a network that meets any of the following communication standards, such as Long Term Evolution (LTE), LTE-Advanced (LTE-A), Wideband Code Division Multiple Access (WCDMA), High-Speed Packet Access (HSPA) and so on.

And, communication between devices in a communication system may be carried out according to a communication protocol at any stage, for example may include but be not limited to the following communication protocols: 1G (generation), 2G, 2.5G, 2.75G, 3G, 4G, 4.5G, and future 5G, New Radio (NR) and so on, and/or other communication protocols that are currently known or will be developed in the future.

In the embodiments of the present disclosure, the term “a network device” refers to, for example, a device that accesses a terminal equipment in a communication system to a communication network and provides services to the terminal equipment. The network device may include but be not limited to the following devices: a Base Station (BS), an Access Point (AP), a Transmission Reception Point (TRP) node, a broadcast transmitter, a Mobile Management Entity (MME), a gateway, a server, a Radio Network Controller (RNC), a Base Station Controller (BSC) and so on.

The base station may include but be not limited to: a node B (NodeB or NB), an evolution node B (eNodeB or eNB) and a 5G base station (gNB), etc., and may further includes a Remote Radio Head (RRH), a Remote Radio Unit (RRU), a relay or a low power node (such as femto, pico, etc.). And the term “base station” may include some or all functions of a base station, each base station may provide communication coverage to a specific geographic region. The term “a cell” may refer to a base station and/or its coverage area, which depends on the context in which this term is used.

In the embodiments of the present disclosure, the term “a User Equipment (UE)” refers to, for example, a device that accesses a communication network and receives network services through a network device, or may also be called “Terminal Equipment (TE)”. The terminal equipment may be fixed or mobile, and may also be called a Mobile Station (MS), a terminal, a user, a Subscriber Station (SS), an Access Terminal (AT) and a station and so on.

The terminal equipment may include but be not limited to the following devices: a Cellular Phone, a Personal Digital Assistant (PDA), a wireless modem, a wireless communication device, a handheld device, a machine-type communication device, a laptop computer, a cordless phone, a smart phone, a smart watch, a digital camera and so on.

For another example, under a scenario such as Internet of Things (IoT), the terminal equipment may also be a machine or apparatus for monitoring or measurement, for example may include but be not limited to: a Machine Type Communication (MTC) terminal, a vehicle-mounted communication terminal, a Device to Device (D2D) terminal, a Machine to Machine (M2M) terminal and so on.

In order that the embodiments of the present disclosure easy to be understood easily, terms and scenarios involved in the embodiments of the present disclosure are illustrated below.

In the embodiments of the present disclosure, an RF repeater with the aforementioned communication function may be called a network-controlled repeater (NCR) or a smart repeater (SR), etc., which is not limited to this.

FIG. 2 is a schematic diagram of an example of a NCR. As shown in FIG. 2, the NCR 21 is functionally divided into two parts, i.e., a NCR-MT (Mobile Termination) 211 and a NCR-Fwd (Forwarding) 212. The NCR-MT 211 is used to communicate with gNB 22 via a Control link (C-link) to perform information interaction. Interactive information, for example, includes side control information, the Control link is based on a Uu interface of NR, and the side control information is at least used to control the NCR-Fwd 212. In addition, the NCR-Fwd 212 is used to perform amplifying and forwarding on an uplink (UL) and/or downlink (DL) RF signal between the gNB 22 and the UE 23 via a Backhaul link (B-link) and an Access link (A-link), a behavior of the NCR-Fwd 212 is controlled according to the side control information received from the gNB 22 and/or other information.

In the above example, the number of the gNBs 22 and the UEs 23 may be one or more, respectively. A gNB communicating with the NCR-MT and a gNB with a corresponding RF signal being amplified and forwarded by the NCR-Fwd may or may not intersect.

Currently, NR supports a larger frequency range. NR Rel-17 defines multiple frequency ranges, such as FR1 and FR2. FR2 may be further divided into FR2-1 and FR2-2.

As a coverage range of a high frequency (such as FR2) is smaller, if the high frequency (such as FR2) is used to ensure basic coverage (for example, supporting initial access of a UE, establishing/reestablishing RRC connection, etc.), it means that a large number of stations need to be deployed at a higher density, and the cost is higher. Thus, in current actual deployment, some operators use a low frequency (such as FR1) to ensure basic coverage. The high frequency (such as FR2) is used as hotspot coverage for traffic off-load or capacity enhancement, and is not used to ensure basic coverage (for example, not supporting initial access of a UE and establishing/reestablishing RRC connection, etc.).

At the same time, since the high frequency has a small coverage range and a signal is easy to be blocked, the NCR may only be used to amplify and forward a signal of the high frequency, not to amplify and forward a signal of a low frequency.

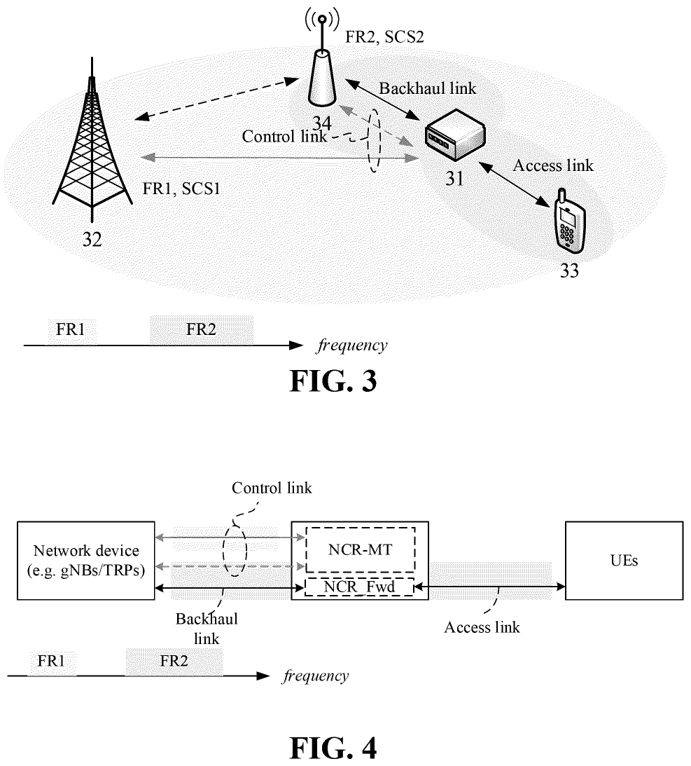

FIG. 3 is a schematic diagram of an example of an implementation scenario in the embodiments of the present disclosure. As shown in FIG. 3, NCR 31 communicates with a first gNB 32 via a Control link (C-link) to achieve information interaction, wherein, the Control link is based on a Uu interface of NR. Moreover, the NCR 31 may further perform amplifying and forwarding on a UL (uplink)/DL (downlink) RF signal between a second gNB 34 and the UE 33 via a Backhaul link and an Access link. For example, operations such as amplify-and-forwarding may be performed according to information received from the first gNB 32.

In addition, in the scenario in FIG. 3, the NCR 31 performs an amplifying and forwarding operation on a signal between the second gNB 34 and the UE 33 at the high frequency (such as FR2) and performs a communicating operation with the first gNB 32 at the low frequency (such as FR1), however the present disclosure is not limited to this. The scenario in FIG. 3 is just illustrative, for example, the NCR 31 may further perform an amplifying and forwarding operation on a signal between the first gNB 32 and the UE 33 at the low frequency (such as FR1) and/or perform a communicating operation with the first gNB 32 at the high frequency (such as FR2). For another example, the second gNB 34 and the first gNB 32 may further be the same, etc.

In the example of FIG. 3, the first gNB 32 and the second gNB 34 may be the same network device or different network devices. The meaning of the network device has been described in the preceding text, and is not repeated here.

FIG. 4 is a schematic diagram of a relation between a link and a frequency range of a NCR. As shown in FIG. 4, a frequency range involved in the Control link is FR1 or FR1 and FR2, that is, the NCR-MT may receive and/or transmit a physical signal at FR1 or FR1 and FR2. A frequency range of a backhaul link and an access link is FR2, that is, NCR-Fwd amplifies and forwards RF signals at FR2.

Various implementations of the embodiments of the present disclosure will be described below with reference to the drawings. These implementations are exemplary only and are not limitations to the present disclosure.

### Embodiments of a First Aspect

The embodiments of the present disclosure provide a communication method.

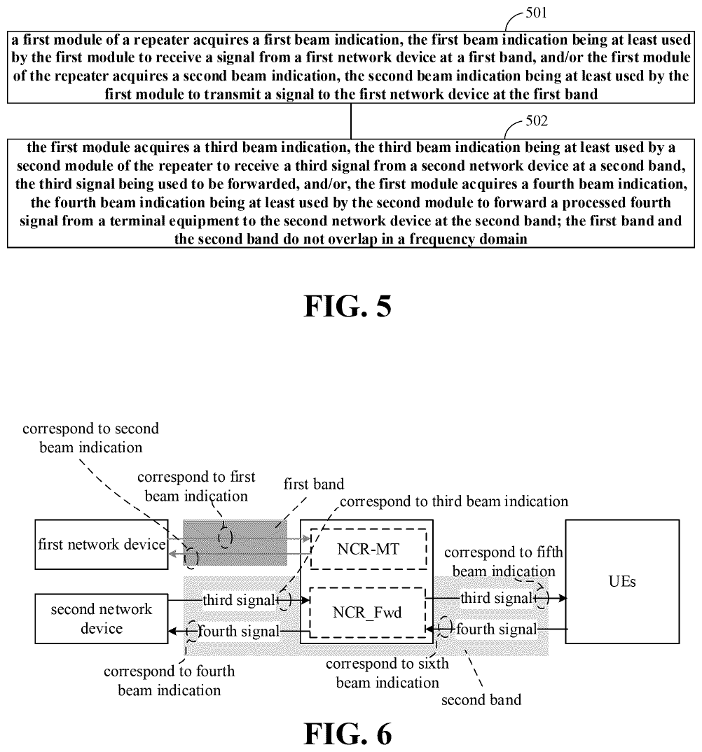

FIG. 5 is a schematic diagram of a communication method in the embodiments of the present disclosure, as shown in FIG. 5, the method includes:
501: a first module of a repeater acquires a first beam indication, the first beam indication being at least used by the first module to receive a signal from a first network device at a first band, and/or the first module of the repeater acquires a second beam indication, the second beam indication being at least used by the first module to transmit a signal to the first network device at the first band;
502: the first module acquires a third beam indication, the third beam indication being at least used by a second module of the repeater to receive a third signal from a second network device at a second band, the third signal being used to be forwarded, and/or, the first module acquires a fourth beam indication, the fourth beam indication being at least used by the second module to forward a processed fourth signal from a terminal equipment to the second network device at the second band; the first band and the second band do not overlap in a frequency domain.

In the embodiments of the present disclosure, the first beam indication and/or the second beam indication is/are used for the first module of the repeater to communicate with the network device (the first network device) at the first band; the third beam indication and/or the fourth beam indication is/are used for the second module of the repeater to forward a signal (RF signal) between the network device (the second network device) and the terminal equipment at the second band. Thereby, communication (information interaction) between the repeater and the base station (the first network device) at the first band, and forwarding, by the repeater, the signal between the base station (the second network device) and the terminal equipment at the second band may be realized. In addition, the first band and the second band do not overlap in the frequency domain, and the repeater may operate in network deployment scenarios where different bands are used for basic coverage and hotspot coverage, respectively. For example, the first band is at a low frequency and used for basic coverage, the second band is at a high frequency and used for hotspot coverage, the first module of the repeater communicates with a network in the first band, the network controls the second module of the repeater how/whether to amplify and forward an RF signal at the second band via side control information and/or other information, so as to expand a hotspot coverage range.

In the above embodiments, that the repeater performs signal forwarding at the second band is taken as an example for description, however the present disclosure is not limited to this. The repeater may further perform signal forwarding at the first band, wherein, an operation of performing signal forwarding at the first band may be incorporated into the second module, or may be implemented by another module (a third module) independent of the second module. For example, the repeater includes two forwarding modules (NCR-Fwd), a first forwarding module is used to perform signal forwarding at the first band, the second forwarding module is used to perform signal forwarding at the second band, and side control information from a network device and/or other information is used to control the first forwarding module and/or the second forwarding module of the repeater. That is, the second module includes a first forwarding module and a second forwarding module; or, the second module includes a second forwarding module, and other module (the third module) independent of the second module includes a first forwarding module.

In some embodiments, the third module is only used to amplify and forward an RF signal.

In some embodiments, the third module is used to receive and/or transmit a physical signal in addition to amplifying and forwarding an RF signal, such as a synchronization signal (such as PSS, SSS), a physical layer broadcast channel (such as PBCH), a reference signal (such as CSI-RS, TRS, SRS, PRS, DMRS, PT-RS), a physical layer control channel (such as PDCCH, PUCCH), and a physical layer data channel (such as PDSCH, PUSCH), etc.

In the above embodiments, that the repeater communicates with a network device (first network device) at the first band is taken as an example for description, however the present disclosure is not limited to this. The repeater may further communicate with the network device (the second network device) at the second band, wherein, an operation of performing communication at the second band may be incorporated into the first module, or may be implemented by another module (a fourth module) independent of the first module. For example, the repeater includes two mobile terminals (NCR-MT), a first mobile terminal is used to communicate with a network device at the first band, and a second mobile terminal is used to communicate with the network device at the second band. That is, the first module includes a first mobile terminal and a second mobile terminal; or, the first module includes a first mobile terminal, other module (the fourth module) independent of the first module includes a second mobile terminal.

For example, in some embodiments, the first beam indication and/or the second beam indication is/are further used for the second module or the third module of the repeater to forward a signal (RF signal) between the network device (the first network device) and the terminal equipment at the first band. For example, the first beam indication is further used for the second module or the third module of the repeater to receive a first signal from the first network device at the first band, the first signal being used to be forwarded, and/or, the second beam indication is further used for the second module or the third module of the repeater to forward a processed second signal from the terminal equipment to the first network device at the first band.

For example, in some embodiments, the third beam indication and/or the fourth beam indication is further used for the first module or the fourth module of the repeater to communicate with the network device (the second network device) at the second band. For example, the third beam indication is further used for the first module or the fourth module of the repeater to receive a signal from the second network device at the second band (second downlink carrier), and/or the fourth beam indication is further used for the first module or the fourth module of the repeater to transmit a signal to the network device (the second network device) at the second band (second uplink carrier).

In the embodiments of the present disclosure, the first module is at least used to receive and/or transmit a physical signal, such as a synchronization signal (such as PSS, SSS), a physical broadcast channel (such as PBCH), a reference signal (such as CSI-RS, TRS, SRS, PRS, DMRS, PT-RS), a physical layer control channel (such as PDCCH, PUCCH), and a physical layer data channel (such as PDSCH, PUSCH), etc. The first module is e.g. a mobile termination (MT) of a repeater, such as the aforementioned NCR-MT, moreover, the first module may further be called by other names.

In the embodiments of the present disclosure, the second module is at least used to amplify and forward an RF signal. The second module is e.g. a forwarding module/unit of a repeater, such as the aforementioned NCR-Fwd, moreover, the second module may further be called by other names.

In some embodiments, the second module is only used to amplify and forward an RF signal.

In some embodiments, the second module is used to receive and/or transmit a physical signal in addition to amplifying and forwarding an RF signal, such as a synchronization signal (such as PSS, SSS), a physical layer broadcast channel (such as PBCH), a reference signal (such as CSI-RS, TRS, PRS, SRS, DMRS, PT-RS), a physical layer control channel (such as PDCCH, PUCCH), and a physical layer data channel (such as PDSCH, PUSCH), etc.

In the above embodiments, that the third signal/the first signal is used to be forwarded refers to that the third signal/the first signal is forwarded after being processed by the repeater, processing here includes amplifying, for example, the repeater receives the third signal/the first signal in a radio frequency domain (that is, the third signal/the first signal is an RF signal), and forwards the third signal/first signal after amplifying the third signal/the first signal.

In the above embodiments, the fourth signal/the second signal comes from a terminal equipment and is a signal that has been processed by the repeater, processing here also includes amplifying. For example, the repeater receives a signal from the terminal equipment, obtains the fourth signal/the second signal after amplifying the signal, and forwards the fourth signal/the second signal to the second network device/the first network device.

In some embodiments, the third beam indication is further used for the first module of the repeater to receive a signal from the second network device at the second band, and/or the fourth beam indication is further used for the first module of the repeater to transmit a signal to the second network device at the second band.

In some embodiments, the first module may further acquire a fifth beam indication, the fifth beam indication being at least used for the second module to transmit a processed third signal at the second band, for example the second module amplifies the third signal, and then transmits the amplified third signal. In addition, in some embodiments, the first module may further acquire a sixth beam indication, the sixth beam indication being at least used for the second module to receive a fourth signal at the second band, for example the second module receives the fourth signal from a terminal equipment at the second band.

In some embodiments, the first to sixth beam indications at least include information related to a beam and/or a spatial filter and/or a reference signal, the information including at least one piece of the following information:
a spatial filter index and/or a beam index;
a reference signal index;
the number of antenna ports of a reference signal;
antenna polarization information;
beam width information; and
beam direction information.

In the above embodiments, the number of antenna ports of the reference signal may be 1 or 2, the antenna polarization information may include single polarization or multi-polarization, the beam width information may include the number of antenna ports with a first dimension and the number of antenna ports with a second dimension, and the beam direction information may include a codebook index, the codebook index may correspond to an angle of departure or an antenna emission phase.

In the embodiments of the present disclosure, a spatial filter may be implicitly indicated via at least one of a spatial filter index, a beam index, and a reference signal index.

For example, a network device only indicates an index of a spatial filter, of a beam or of a reference signal to be used, and a repeater determines a specific spatial filter to be used, according to the index. In this case, for example, the repeater receives CSI-RS configuration, the CSI-RS configuration is neither used for reception of a CSI-RS, nor for transmission of the CSI-RS, but for the repeater to determine a spatial filter to be used.

In the embodiments of the present disclosure, the spatial filter may further be explicitly indicated via antenna polarization information, beam width information and beam direction information. That is, via the antenna polarization information, beam width information and beam direction information, a specific spatial filter is indicated to the repeater.

For example, the number of antenna ports of the reference signal is 1 or 2.

For example, the antenna polarization information includes single polarization or multi-polarization.

In the embodiments of the present disclosure, the above two points may be combined, i.e., the number of antenna ports of the reference signal and the antenna polarization information may be combined or corresponding. For example, the number of antenna ports being 1 corresponds to a single-polarized antenna, and the number of antenna ports being 2 corresponds to a dual-polarized antenna, or, if an antenna of a repeater is single-polarized, the number of antenna ports of a corresponding reference signal is 1; if an antenna of a repeater is dual-polarized, the number of antenna ports of a corresponding reference signal is 2.

For example, the beam width information includes the number n1 of antenna ports with a first dimension and the number n2 of antenna ports with a second dimension. For example, the first dimension is a horizontal dimension, and the second dimension is a vertical dimension.

In the above example, n1≤N1, n2≤N2, N1 and N2 are the maximum number of antenna ports with the first dimension supported by the repeater and the maximum number of antenna ports with the second dimension supported by the repeater, respectively.

For example, the beam direction information includes a codebook index.

For example, the repeater may be configured with one or more candidate codebook indexes. Each codebook index corresponds to an angle of departure or an antenna emission phase. A network device transmits a codebook index indication to the repeater, the indication corresponds to one or more of the above candidate codebook indexes. Thereby, a terminal equipment determines a spatial filter (e.g., beam direction and/or beam width) used to transmit or receive a signal, according to an indicated codebook index.

In some embodiments, that each of the beam indications is at least used by the first module or the second module to transmit a signal and/or receive a signal refers to that the first module or the second module transmit a signal and/or receive a signal by using a spatial filter corresponding to each of the beam indications.

In the above embodiments, each of the beam indications refers to the first to sixth beam indications, for example, that the first beam indication is at least used by the first module to receive a signal from a first network device at a first band refers to that the first module receives a signal from a first network device by using a spatial filter corresponding to the first beam indication. For another example, that the second beam indication is at least used by the first module to transmit a signal to a first network device at a first band refers to that the first module transmits a signal to a first network device by using a spatial filter corresponding to the second beam indication. For another example, that the third beam indication is at least used by the second module to receive a third signal from a second network device at a second band refers to that the second module receives a third signal from a second network device by using a spatial filter corresponding to the third beam indication. For a further example, that the fourth beam indication is at least used by the second module to forward a processed fourth signal from a terminal equipment to a second network device at a second band refers to that the second module forwards a processed fourth signal from a terminal equipment to a second network device at a second band by using a spatial filter corresponding to the fourth beam indication. Regarding the fifth beam indication and the sixth beam indication, the meaning of “being at least used” is similar to that for the first to fourth beam indications, and its description is omitted here.

In some embodiments, the first to sixth beam indications are carried by dynamic signaling or semi-static signaling. The dynamic signaling may e.g. be downlink control information (DCI) or a physical downlink control channel (PDCCH). The semi-static signaling may e.g. be a MAC CE (Media Access Control Control Element) signaling or RRC (Radio Resource Control) signaling.

In the embodiments of the present disclosure, the first network device and the second network device may be the same or different. Taking the scenario in FIG. 3 as an example, the first network device may be a first gNB 32, and the second network device may be a second gNB 34, however the present disclosure is not limited to this. As shown in FIG. 2, both the first network device and the second network device may all be the first gNB 32 or the second gNB 34.

FIG. 6 is a schematic diagram of a network architecture corresponding to the method in FIG. 5. In FIG. 6, that the first module is a NCR-MT and the second module is a NCR-Fwd is taken as an example. As shown in FIG. 6, the NCR-MT acquires the first to sixth beam indications, the NCR-MT receives a signal from a first network device at a first band according to the first beam indication, and transmits the signal to the first network device at the first band according to the second beam indication. In addition, the NCR-Fwd receives a third signal from a second network device at a second band according to the third beam indication, processes the third signal and then forwards the processed third signal to a UE at the second band according to the fifth beam indication. Moreover, the NCR-Fwd further receives a fourth signal from the UE at the second band according to the sixth beam indication, processes the fourth signal, and then forwards the processed fourth signal to the second network device at the second band according to the fourth beam indication.

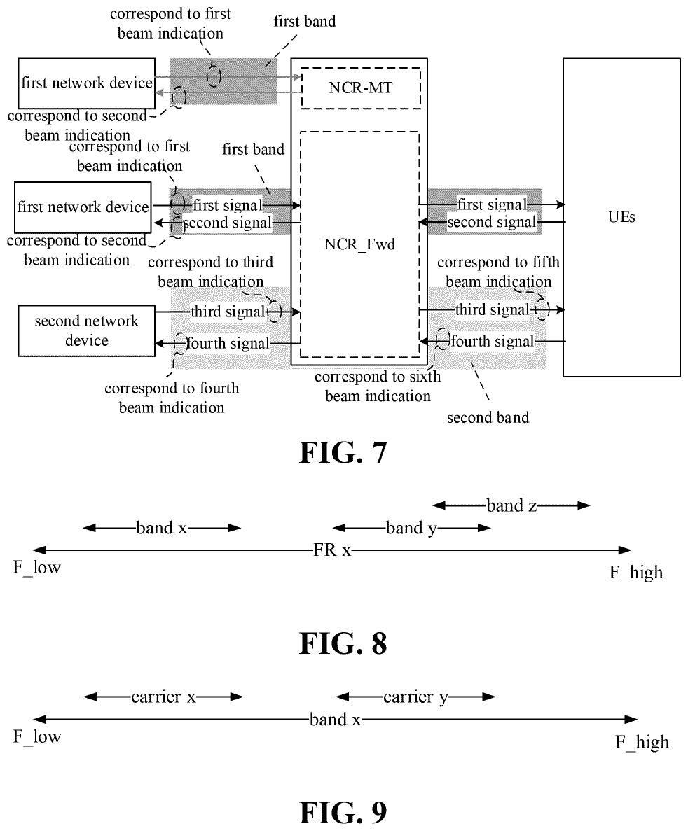

FIG. 7 is another schematic diagram of a network architecture corresponding to the method in FIG. 5. In FIG. 7, that the first module is a NCR-MT and the second module is a NCR-Fwd is taken as an example. As shown in FIG. 7, the NCR-MT acquires the first to sixth beam indications, and unlike the example in FIG. 6, the NCR-Fwd may further receive the first signal from the first network device at the first band according to the first beam indication, amplify the first signal, and transmit the processed first signal to the UE at the first band, and/or, the NCR-Fwd may further receive a second signal from the UE at the first band, amplify the second signal, and transmit the processed second signal to the first network device at the first band according to the second beam indication.

In the embodiments of the present disclosure, the first band and the second band may be located within different frequency ranges. For example, the first band is located within a first frequency range, and the second band is located within a second frequency range.

In the embodiments of the present disclosure, the first frequency range and the second frequency range do not overlap in a frequency domain and each includes one or more operating bands. For example, the first frequency range is FR1, and the second frequency range is FR2. For another example, the first frequency range is FR1, and the second frequency range is FR2-1. For a further example, the first frequency range is FR2-1, and the second frequency range is FR2-2.

In some embodiments, subcarrier spacing (SCS) of the first frequency range and subcarrier spacing of the second frequency range are different. “Different” refers to not exactly the same or completely different (no intersection). For example, a subcarrier spacing of the first frequency range may be 15 kHz and/or 30 kHz, and a subcarrier spacing of the second frequency range may be 60 kHz and/or 120 kHz. For another example, a subcarrier spacing of the first frequency range may be 15 kHz and/or 30 kHz and/or 60 kHz, and a subcarrier spacing of the second frequency range may be 60 kHz and/or 120 kHz.

In some embodiments, the subcarrier spacing of a frequency range refers to a subcarrier spacing defined for the frequency range. The subcarrier spacing defined for a band within the first frequency range refers to a subset of the subcarrier spacing defined for the frequency range.

In some embodiments, subcarrier spacing (SCS) of the first band and subcarrier spacing of the second band are different. “Different” refers to not exactly the same or completely different (no intersection). For example, a subcarrier spacing of the first band may be 15 kHz and/or 30 kHz, and a subcarrier spacing of the second band may be 60 kHz and/or 120 kHz. For another example, a subcarrier spacing of the first band may be 15 kHz and/or 30 kHz and/or 60 kHz, and a subcarrier spacing of the second band may be 60 kHz and/or 120 KHz.

In some embodiments, the subcarrier spacing of a band refers to a subcarrier spacing defined for the band. For example, as shown in the table below, the subcarrier spacings of band n1/n2 are 15, 30, 60 KHz. A carrier configured within that band may use one or more of the subcarrier spacings defined for that band (different BWPs in a carrier may use the same or different subcarrier spacings).

NR band/SCS/BS channel bandwidth

| | | | | | | | | | | | | | | |
|---|---|---|---|---|---|---|---|---|---|---|---|---|---|---|
| NR | SCS | 5 | 10 | 15 | 20 | 25 | 30 | 40 | 50 | 60 | 70 | 80 | 90 | 100 |
| Band | kHz | MHz | MHz | MHz | MHz | MHz | MHz | MHz | MHz | MHz | MHz | MHz | MHz | MHz |

| | | | | | |
|---|---|---|---|---|---|
| n1 | 15 | Yes | Yes | Yes | Yes |
| | 30 | | Yes | Yes | Yes |
| | 60 | | Yes | Yes | Yes |
| n2 | 15 | Yes | Yes | Yes | Yes |
| | 30 | | Yes | Yes | Yes |
| | 60 | | Yes | Yes | Yes |

In some embodiments, the first band includes a first carrier (or a first cell), the first carrier (or the first cell) including a first downlink carrier and/or a first uplink carrier. That the first band includes a first carrier refers to that, in a frequency domain, the first carrier is within the first band. That is, a bandwidth of the first carrier is within a bandwidth of the first band. The first band is of TDD (time division duplex) (unpaired) or FDD (frequency division duplex) (paired) or SDL or SUL. If the first band is of FDD, the first band includes a first downlink band and a first uplink band, the first downlink band including a first downlink carrier, and the first uplink band including a first uplink carrier. That the first band includes a first cell refers to that, a carrier (including a first downlink carrier and/or a first uplink carrier) of the first cell is within the first band.

FIG. 8 is a schematic diagram of an instance of a relation between a frequency range (FR) and a band within the FR in a frequency domain. FIG. 9 is a schematic diagram of an instance of a relation between a band and a carrier in the band in a frequency domain.

In the above embodiments, the first downlink carrier and the first uplink carrier may be of the same frequency (that is, they are in the same position in a frequency domain), or may be of different frequencies (that is, they do not overlap in the frequency domain).

In some embodiments, the second band includes a second carrier (or a second cell), the second carrier (or the second cell) including a second downlink carrier and/or a second uplink carrier. That the second band includes a second carrier refers to that, in a frequency domain, the second carrier is within the second band. That is, a bandwidth of the second carrier is within a bandwidth of the second band. The second band is of TDD (unpaired) or FDD (paired) or SDL or SUL. If the second band is of FDD, the second band includes a second downlink band and a second uplink band, the second downlink band including a second downlink carrier, and the second uplink band including a second uplink carrier. That the second band includes a second cell refers to that a carrier (including a second downlink carrier and/or a second uplink carrier) of the second cell is within the second band.

In the above embodiments, the second downlink carrier and the second uplink carrier may be of the same frequency (that is, they are in the same position in a frequency domain), or may be of different frequencies (that is, they do not overlap in the frequency domain).

In each of the above embodiments, being in the same position in the frequency domain refers to that center frequencies (frequency points) are the same (that is, corresponding bands are of TDD). Moreover, in each of the above embodiments, not overlapping in the frequency domain includes that center frequencies (frequency points) are different (that is, corresponding bands are of FDD).

In some embodiments, subcarrier spacing of the first downlink carrier and subcarrier spacing of the second downlink carrier are different. “Different” refers to not exactly the same or completely different (no intersection). For example, the SCS of the first downlink carrier is 15 kHz, and the SCS of the second downlink carrier is 120 kHz.

In some embodiments, subcarrier spacing of the first uplink carrier and subcarrier spacing of the second uplink carrier are different. “Different” refers to not exactly the same or completely different (no intersection). For example, the SCS of the first uplink carrier is 15 kHz, and the SCS of the second uplink carrier is 120 kHz.

In some embodiments, the first module may receive (including processing such as demodulation, and/or measurement, and/or decoding, and/or interpretation, etc.) and/or transmit (including processing such as physical resource mapping, etc.) a signal at the second band.

For example, the first module receives a signal from a first network device at the second band according to the third beam indication, and/or the first module transmits a signal to the first network device at the second band according to the fourth beam indication.

In each of the above embodiments, the first module may receive a signal on one or more carriers of the first band and/or the second band, for example receives an SSB, a CSI-RS, a PDCCH, a PDSCH, etc., and the first module may further transmit a signal on one or more carriers of the first band and/or the second band, for example transmits a PRACH, an SRS, a PUCCH, a PUSCH, etc.

In the above embodiments, in a case where the first module receives a signal on multiple carriers of the first band and/or the second band, types of a signal received by the first module at different bands or different carriers are the same or different, that is, signals that need to be received and configured for different bands or different carriers are the same or different. For example, types of a signal received by the first module at two bands or carriers are the same, including an SSB, a CSI-RS, a PDCCH, a PDSCH, etc. For another example, types of a signal received by the first module at two bands or carriers are different, an SSB, a CSI-RS, a PDCCH, a PDSCH, etc. are received at one of downlink carriers, and only an SSB and a CSI-RS are received at the other downlink carrier. The above are illustrative only, the present disclosure is not limited to this.

In the above embodiments, in a case where the first module transmits a signal on multiple carriers of the first band and/or the second band, types of a signal transmitted by the first module at different bands or different carriers are the same or different, that is, signals that need to be transmitted and configured for different bands or different carriers are the same or different. For example, types of a signal transmitted by the first module at two bands or carriers are the same, including a PRACH, an SRS, a PUCCH, a PUSCH, etc. For another example, types of a signal transmitted by the first module at two bands or carriers are different, a PRACH, an SRS, a PUCCH, a PUSCH, etc. are transmitted at one of uplink carriers, and only a PRACH is transmitted at the other uplink carrier.

In some embodiments, the first module may receive a first reference signal at the first downlink carrier and/or the second downlink carrier, such as an SSB, a CSI-RS, etc.

In some embodiments, the first reference signal is a downlink reference signal. The first reference signal is used for beam management. The first reference signal includes e.g. an SSB and/or a CSI-RS.

In some embodiments, the first reference signal includes one or more SSBs corresponding to different SSB indexes, and/or one or more CSI-RSes corresponding to different CSI-RS IDs.

In the above embodiments, the first module may further transmit a measurement report of the first reference signal on the first downlink carrier and/or the second downlink carrier.

In some embodiments, the measurement report of the first reference signal includes one or more reference signal indexes and/or one or more measurement results (such as an RSRP, an RSRQ, a SINR) corresponding to the reference signal indexes respectively. For example, the first reference signal includes an SSB and a CSI-RS, and the measurement report of the first reference signal includes one or more SSB indexes and/or one or more CSI-RS IDs, and/or, measurement results (such as one or more of an RSRP, an RSRQ, a SINR) corresponding to the SSB indexes and/or CSI-RS IDs respectively. For another example, the first reference signal includes an SSB, and the measurement report of the first reference signal includes one or more SSB indexes, and/or, measurement results (such as one or more of an RSRP, an RSRQ, a SINR) corresponding to one or more SSB indexes respectively. For another example, the first reference signal includes one or more CSI-RSes, and the measurement report of the first reference signal includes one or more CSI-RS IDs, and/or, measurement results (such as one or more of an RSRP, an RSRQ, a SINR) corresponding to one or more CSI-RS IDs.

In some embodiments, the first module may transmit a second reference signal at the first uplink carrier and/or the second uplink carrier, such as an SRS, etc.

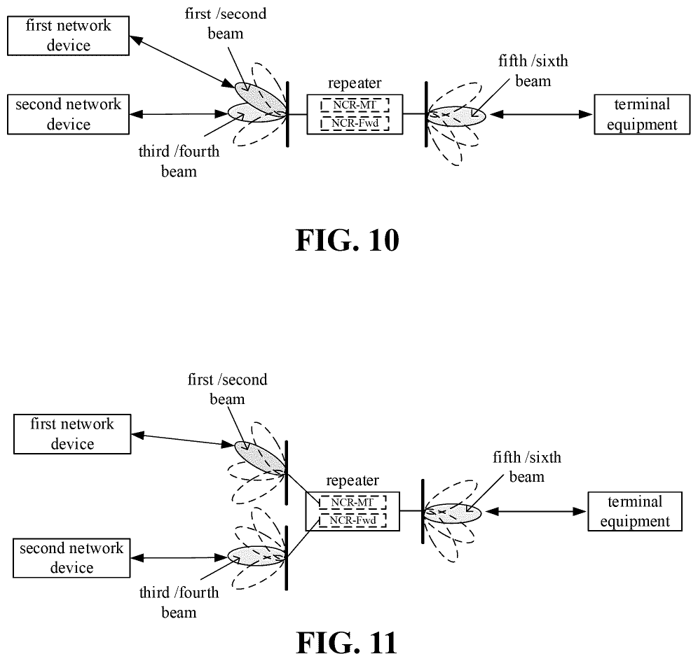

FIG. 10 is a schematic diagram of first to sixth beams. In this example, it is assumed that a repeater has the same transceiving beam for the same device, and the same antenna panel is used at a network side. As shown in FIG. 10, the repeater communicates with the first network device via the first beam and/or the second beam, for example the repeater receives a signal from the first network device at the first band by using the first beam, or transmits a signal to the first network device at the first band by using the second beam. Moreover, the repeater communicates with the second network device via the third beam and/or the fourth beam, for example the repeater receives a signal (for example receives a third signal) from the second network device at the second band by using the third beam, or transmits a signal (for example transmits a processed fourth signal) to the second network device at the second band by using the fourth beam. Moreover, the repeater further communicates with a terminal equipment via the fifth beam and/or the sixth beam, for example the repeater transmits a signal (for example transmits a processed third signal) to the terminal equipment at the second band by using the fifth beam, or receives a signal (for example receives a fourth signal) from the terminal equipment at the second band by using the sixth beam.

FIG. 11 is another schematic diagram of first to sixth beams. Unlike the example in FIG. 10, in this example, different antenna panels are used at a network side. Use mode of each beam is similar to that in FIG. 10, and the description is omitted here.

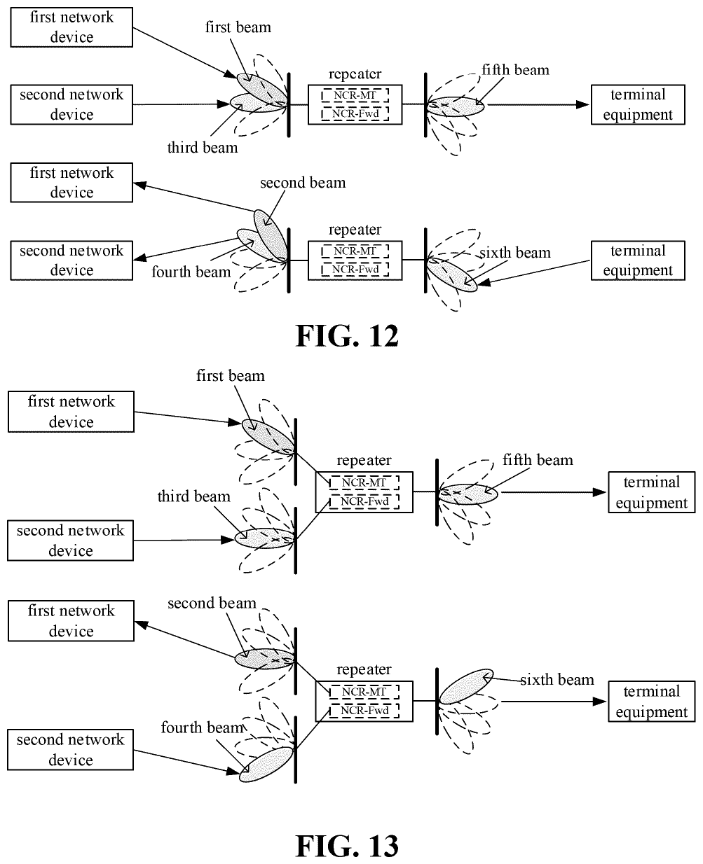

FIG. 12 is a further schematic diagram of first to sixth beams. In this example, it is assumed that a repeater has different transceiving beams for the same device, and the same antenna panel is used at a network side. As shown in FIG. 12, the repeater communicates with the first network device via the first beam and the second beam, for example the repeater receives a signal from the first network device at the first band by using the first beam, and transmits a signal to the first network device at the first band by using the second beam. Moreover, the repeater communicates with the second network device via the third beam and the fourth beam, for example the repeater receives a signal (for example receives a third signal) from the second network device at the second band by using the third beam, and transmits a signal (for example transmits a processed fourth signal) to the second network device at the second band by using the fourth beam. Moreover, the repeater further communicates with a terminal equipment via the fifth beam and the sixth beam, for example the repeater transmits a signal (for example transmits a processed third signal) to the terminal equipment at the second band by using the fifth beam, and receives a signal (for example receives a fourth signal) from the terminal equipment at the second band by using the sixth beam.

FIG. 13 is a further schematic diagram of first to sixth beams. Unlike the example in FIG. 12, in this example, different antenna panels are used at a network side. Use mode of each beam is similar to that in FIG. 12, and the description is omitted here.

In each of the above embodiments, the first and second bands refer to operating bands or passbands, however the present disclosure is not limited to this.

In the embodiments of the present disclosure, the carrier for receiving a signal (downlink carrier) and/or the carrier for transmitting a signal (uplink carrier) by a MT of a repeater is called a carrier of the MT of the repeater. The carrier of the MT of the repeater includes one or more carriers.

In the embodiments of the present disclosure, “more” refers to more than one, or two or more.

In some embodiments, the carrier of the MT of the repeater is not within a band (or passband or carrier) range of a forwarding module of the repeater. That is, the forwarding module of the repeater does not forward a signal (RF signal) on the carrier of the MT of the repeater.

In some embodiments, at least one carrier of the MT of the repeater is within a band (or passband or carrier) range of a forwarding module of the repeater. That is, the forwarding module of the repeater forwards a signal (RF signal) on at least one carrier of the MT of the repeater.

In some embodiments, at least one carrier of the MT of the repeater is within a band (or passband or carrier) range of a forwarding module of the repeater, and at least one carrier of the MT of the repeater is not within a band (or passband or carrier) range of the forwarding module of the repeater. That is, the forwarding module of the repeater forwards a signal (RF signal) on at least one carrier of the MT of the repeater, and the forwarding module of the repeater does not forward a signal (RF signal) on at least one carrier of the MT of the repeater.

In each of the above embodiments, the band (or passband or carrier) of the forwarding module of the repeater refers to a band (or passband or carrier) at which a signal is forwarded by the forwarding module of the repeater, or an operating band of the forwarding module of the repeater. The band (or passband or carrier) of the forwarding module of the repeater includes one or more bands (passbands or carriers).

In some embodiments, the repeater (MT or forwarding module) does not receive a physical control channel (e.g. a PDCCH) and/or a physical data channel (e.g. a PDSCH) at the second downlink carrier. For example, the repeater only receives an SSB and/or a CSI-RS at the second downlink carrier.

In some embodiments, the repeater (MT or forwarding module) does not transmit a physical control channel (e.g. a PUCCH) and/or a physical data channel (e.g. a PUSCH) at the second uplink carrier. For example, the repeater only receives a PRACH and/or an SRS at the second uplink carrier.

In some embodiments, the repeater transmits capability information to a network device, the capability information is used to indicate an operating band supported by the MT and/or forwarding module of the repeater, and/or, the number of TAGs (Timing Advance Groups) supported by the MT of the repeater, and/or, whether the MT of the repeater supports carrier aggregation, and/or, the maximum number of carriers supported by the MT of the repeater, and/or, whether the forwarding module of the repeater may receive a signal.

In some embodiments, the repeater transmits capability information related to a beam/an antenna to a network device, such as the number of beams supported by a network device side (or B-link and C-link) of the repeater, the number of beams supported by a terminal equipment side (or A-link) of the repeater, the number of beams supported by B-link of the repeater, and the number of ports supported by C-link (or MT) of the repeater.

The method in the embodiments of the present disclosure is illustrated below in conjunction with specific examples.

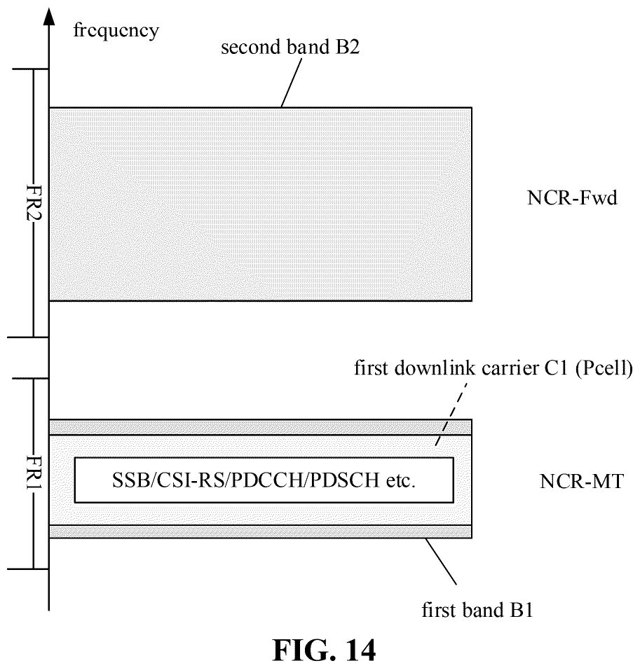

FIG. 14 is a schematic diagram of an example in which a repeater receives a signal according to a method in the embodiments of the present disclosure.

As shown in FIG. 14, in this example, the carrier (first downlink carrier C1) of the MT of the repeater is not within the band (second band B2) of the forwarding module of the repeater. The first module (NCR-MT) of the repeater receives a signal on the first downlink carrier C1 of the first band, for example receives one or more of an SSB, a CSI-RS, a PDCCH, a PDSCH, etc. The forwarding module (NCR-Fwd) of the repeater forwards a signal at the second band B2.

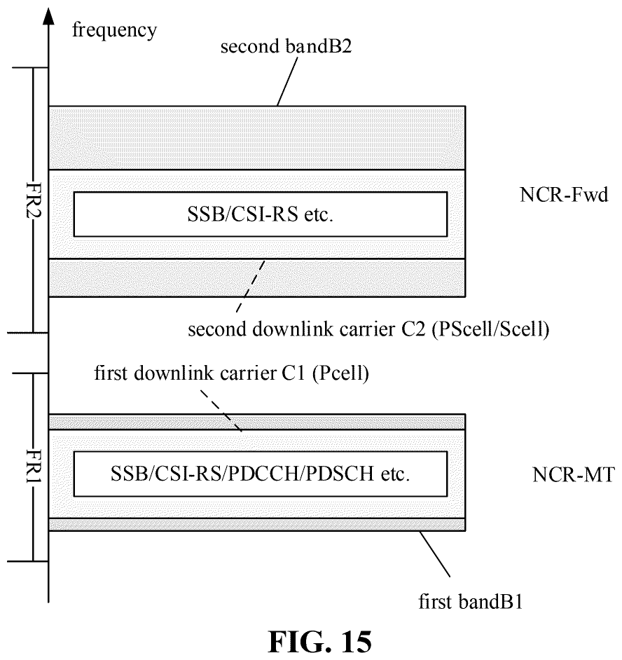

FIG. 15 is a schematic diagram of another example in which a repeater receives a signal according to a method in the embodiments of the present disclosure.

As shown in FIG. 15, in this example, the repeater receives a signal on two or more carriers of the first band and/or the second band, two carriers therein are called the first downlink carrier C1 and the second downlink carrier C2, respectively. The MT of the repeater receives a signal on the first downlink carrier C1, for example receives one or more of an SSB, a CSI-RS, a PDCCH, a PDSCH, etc.

In addition, for the second downlink carrier C2, in some cases, the MT (NCR-MT) of the repeater receives a signal on the second downlink carrier C2, for example receives an SSB and/or a CSI-RS, that is, at least one carrier (first downlink carrier C1) of the MT of the repeater is not within the band (second band B2) of the forwarding module of the repeater, at least one carrier (second downlink carrier C2) is within the band (second band B2) of the forwarding module of the repeater; in some other cases, the forwarding module (NCR-Fwd) of the repeater receives a signal on the second downlink carrier C2, for example receives an SSB and/or a CSI-RS, that is, the carrier (first downlink carrier C1) of the MT of the repeater is not within the band (second band B2) of the forwarding module of the repeater, and the forwarding module of the repeater receives a signal on the carrier (second downlink carrier C2) within its band (second band B2).

In the above example, the first downlink carrier C1 and/or the second downlink carrier C2 are subordinate or not subordinate to a cell, for example, the first downlink carrier C1 is subordinate to a cell, and the second downlink carrier C2 is not subordinate to a cell. In a case where the first downlink carrier C1 and the second downlink carrier C2 are subordinate to a cell, the first downlink carrier C1 and the second downlink carrier C2 belong to the same cell or different cells. In FIG. 12 and FIG. 13, it is assumed that the first downlink carrier C1 and the second downlink carrier C2 belong to different cells, the first downlink carrier C1, for example, belongs to Pcell (that is, the first downlink carrier C1 is a downlink carrier of the Pcell), and the second downlink carrier C2, for example, belongs to PScell or Scell (that is, the second downlink carrier C2 is a downlink carrier of the PScell or Scell), however the present disclosure is not limited to this.

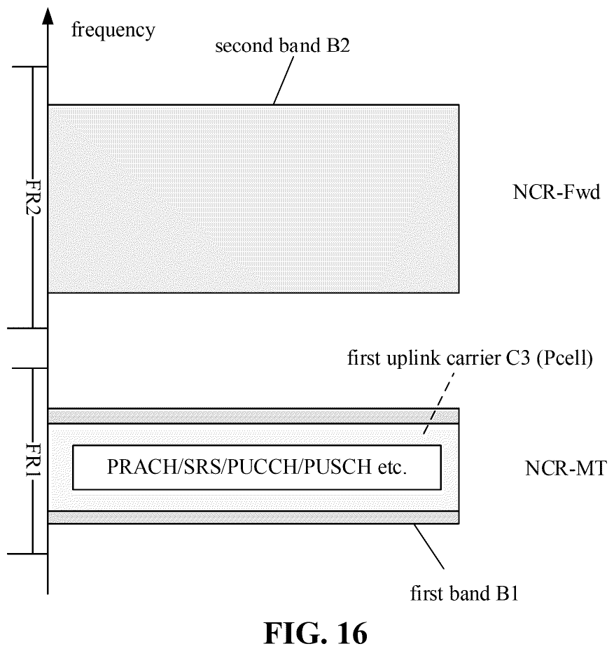

FIG. 16 is a schematic diagram of an example in which a repeater transmits a signal according to a method in the embodiments of the present disclosure.

As shown in FIG. 16, in this example, the carrier (first uplink carrier C3) of the MT of the repeater is not within the band (second band B2) of the forwarding module of the repeater. The first module (NCR-MT) of the repeater transmits a signal on the first uplink carrier C3, for example transmits one or more of a PRACH, an SRS, a PUCCH, a PUSCH, etc. The forwarding module (NCR-Fwd) of the repeater forwards a signal at the second band B2.

From the point of view of a center frequency and/or a cell to which it belongs, the first uplink carrier C3 and the first downlink carrier C1 are the same or different. That is, the first uplink carrier C3 and the first downlink carrier C1 may be an uplink carrier and a downlink carrier of the same cell (e.g. Pcell), respectively. Both of them are of TDD or FDD.

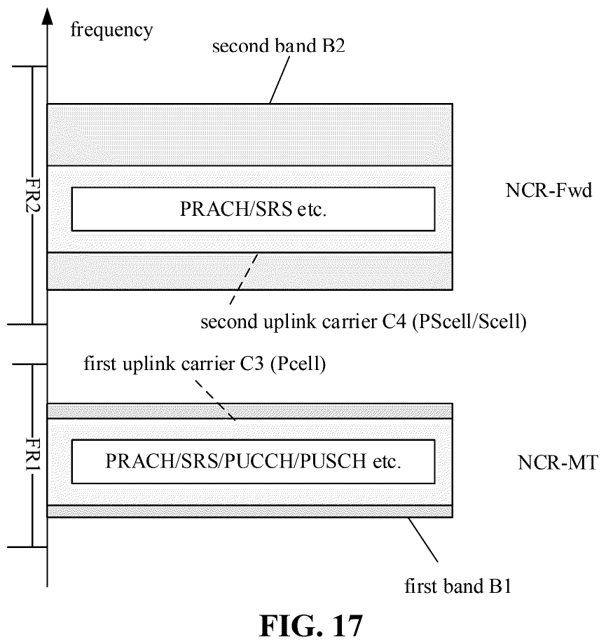

FIG. 17 is a schematic diagram of another example in which a repeater transmits a signal according to a method in the embodiments of the present disclosure.

As shown in FIG. 17, the repeater transmits a signal on two or more carriers of the first band and/or the second band, two carriers therein are called a first uplink carrier C3 and a second uplink carrier C4, respectively. The MT of the repeater transmits a signal on the first uplink carrier C3, for example transmits one or more of a PRACH, an SRS, a PUCCH, a PUSCH, etc.

For the second uplink carrier C4, in some cases, the MT (NCR-MT) of the repeater transmits a signal on the second uplink carrier C4, for example transmits a PRACH and/or an SRS, etc., that is, at least one carrier (first uplink carrier C3) of the MT of the repeater is not within the band (second band B2) of the forwarding module of the repeater, at least one carrier (second uplink carrier C4) is within the band (second band B2) of the forwarding module of the repeater; in some other cases, the forwarding module (NCR-Fwd) of the repeater transmits a signal on the second uplink carrier C4, for example transmits a PRACH and/or an SRS, etc., that is, the carrier (first uplink carrier C3) of the MT of the repeater is not within the band (second band B2) of the forwarding module of the repeater, and the forwarding module of the repeater transmits a signal on the carrier (second uplink carrier C4) within its band (second band B2).

From the point of view of a center frequency and/or a cell to which it belongs, the first uplink carrier C3 and the first downlink carrier C1 are the same or different, the second uplink carrier C4 and the second downlink carrier C2 are the same or different. That is, the first uplink carrier C3 and the first downlink carrier C1 may be an uplink carrier and a downlink carrier of the same cell (e.g. Pcell), respectively. Both of them are of TDD or FDD. The second uplink carrier C4 and the second downlink carrier C2 may be an uplink carrier and a downlink carrier of the same cell (e.g. PScell/Scell), respectively. Both of them are of TDD or FDD.

In the above example, the first downlink carrier C1 and/or the second downlink carrier C2 and/or the first uplink carrier C3 and/or the second uplink carrier C4 are subordinate to or not subordinate to a cell. In a case where the first downlink carrier C1 and the second downlink carrier C2 are subordinate to a cell, the first downlink carrier C1 and the second downlink carrier C2 belong to the same cell or different cells. In a case where the first uplink carrier C3 and the second uplink carrier C4 are subordinate to a cell, the first uplink carrier C3 and the second uplink carrier C4 belong to the same cell or different cells. For a case where the first downlink carrier C1 and the second downlink carrier C2 belong to the same cell, for example, the first downlink carrier C1 is a NDL carrier of the cell, the second downlink carrier C2 is an SDL carrier of the cell, or vice versa; for a case where the first uplink carrier C3 and the second uplink carrier C4 belong to the same cell, for example, the first uplink carrier C3 is a NUL carrier of the cell, the second uplink carrier C4 is an SUL carrier of the cell, or vice versa.

In the above example, it is assumed that the first downlink carrier C1/the first uplink carrier C3 and the second downlink carrier C2/the second uplink carrier C4 belong to different cells, the first downlink carrier C1/the first uplink carrier C3 for example belong to Pcell, and the second downlink carrier C2/the second uplink carrier C4 for example belong to PScell or Scell, however the present disclosure is not limited to this.

In the examples shown in FIGS. 14 to 17, in some implementations, the first module receives a signal in a downlink BWP of a downlink carrier, and/or, transmits a signal in an uplink BWP of an uplink carrier, however the present disclosure is not limited to this.

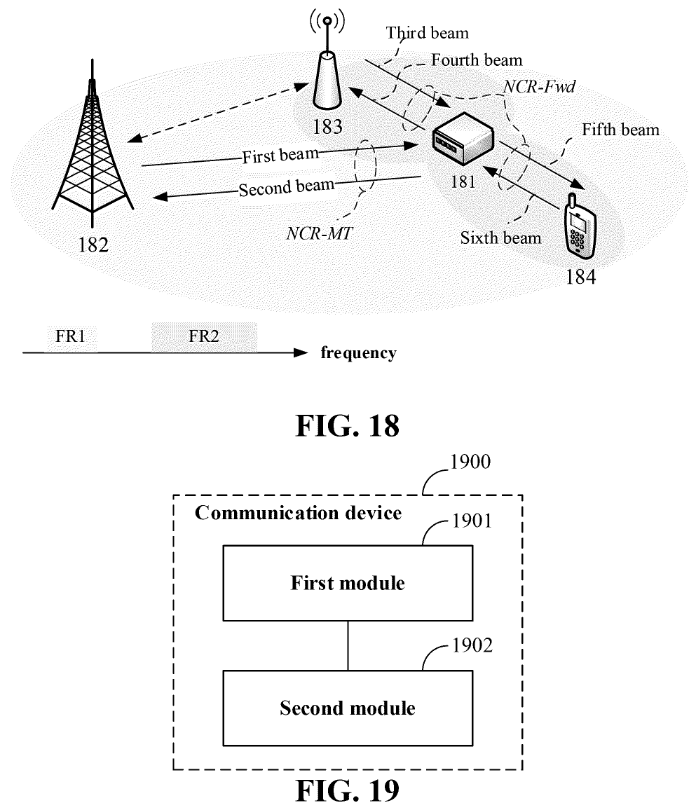

FIG. 18 is a schematic diagram of an example in which a repeater forwards a signal according to a method in the embodiments of the present disclosure.

As shown in FIG. 18, the repeater 181 may transmit capability information related to beam/antenna of a backhaul link (A-link) to the first network device 182, receive an SSB and/or a CSI-RS from the second network device 183 on the second downlink carrier, and transmit a measurement report of the second downlink carrier to the first network device 182, and/or, transmit an SRS to the second network device 183 on the second uplink carrier, thereby to determine a beam (third beam and/or fourth beam) adopted by a backhaul link (B-link) according to corresponding beam indication information received from the first network device 182.

In addition, the repeater 181 may transmit capability information related to beam/antenna of a control link (C-link) to the first network device 182, receive an SSB and/or a CSI-RS from the first network device 182 on the first downlink carrier, and transmit a measurement report of the second downlink carrier to the first network device 182, and/or, transmit an SRS to the first network device 182 on the first uplink carrier, thereby to determine a beam (first beam and/or second beam) adopted by the control link (C-link) according to corresponding beam indication information received from the first network device 182.

Moreover, the repeater 181 may transmit capability information related to beam/antenna of a control link (A-link) to the first network device 182, and determine an identifier of a beam of the control link (A-link), thereby to determine a beam (first beam and/or second beam) adopted by the control link (A-link) according to corresponding beam indication information received from the first network device 182.

In the embodiments of the present disclosure, that the first module acquires beam indications, may also be that the first module receives the beam indications, the present disclosure does not limit an acquiring mode and a receiving mode.

Each of the above embodiments is only illustrative for the embodiments of the present disclosure, but the present disclosure is not limited to this, appropriate modifications may be also made based on the above each embodiment. For example, each of the above embodiments may be used individually, or one or more of the above embodiments may be combined.

The above only describes each step or process related to the present disclosure, but the present disclosure is not limited to this. The method in the embodiments of the present disclosure may further include other steps or processes. For specific contents of these steps or processes, relevant technologies may be referred to.

In the embodiments of the present disclosure, the repeater may be a transponder, a radio frequency repeater, a radio frequency relay, a transponder node, a repeater node, a relay node, an intelligent transponder, an intelligent repeater, an intelligent relay, an intelligent transponder node, an intelligent repeater node, an intelligent relay node, etc., however the present disclosure is not limited to this, it may further be other device.

According to the method in the embodiments of the present disclosure, by obtaining a first beam indication and/or a second beam indication, communication (information interaction) between a repeater and a base station (a first network device) may be achieved. In addition, by obtaining a third beam indication and/or a fourth beam indication, forwarding of a signal between a base station (a second network device) and a terminal equipment by the repeater may be achieved.

### Embodiments of a Second Aspect

The embodiments of the present disclosure provide a communication device, the device may, for example, be a repeater, or may further be one or more parts or components configured on the repeater.

FIG. 19 is a schematic diagram of a communication device in the embodiments of the present disclosure. The principle of the device to solve the problem is the same as the device in the embodiments of the first aspect, thus its specific implementation may refer to the implementation of the device in the embodiments of the first aspect, the same contents will not be repeated.

As shown in FIG. 19, the device 1900 in the embodiments of the present disclosure includes a first module 1901 and a second module 1902.

In the embodiments of the present disclosure, the first module 1901 acquires a first beam indication, the first beam indication being at least used by the first module 1901 to receive a signal from a first network device at a first band, and/or the first module 1901 acquires a second beam indication, the second beam indication being at least used by the first module 1901 to transmit a signal to the first network device at the first band; moreover, the first module 1901 further acquires a third beam indication, the third beam indication being at least used by the second module 1902 to receive a third signal from a second network device at a second band, the third signal being used to be forwarded, and/or, the first module 1901 acquires a fourth beam indication, the fourth beam indication being at least used by the second module 1902 to forward a processed fourth signal from a terminal equipment to the second network device at the second band. In the embodiments of the present disclosure, the first band and the second band do not overlap in a frequency domain.

In some embodiments, the third beam indication is further used for the first module 1901 to receive a signal from the second network device at the second band, and/or the fourth beam indication is further used for the first module 1901 to transmit a signal to the second network device at the second band.

In some embodiments, the first module 1901 further acquires a fifth beam indication, the fifth beam indication being at least used by the second module 1902 to transmit a processed third signal at the second band, and/or, the first module 1901 further acquires a sixth beam indication, the sixth beam indication being at least used by the second module 1902 to receive the fourth signal at the second band.

In some embodiments, the first to sixth beam indications at least include information related to a beam and/or a spatial filter and/or a reference signal, the information including at least one piece of the following information:
a spatial filter index and/or a beam index;
a reference signal index;
the number of antenna ports of a reference signal;
antenna polarization information;
beam width information; and
beam direction information.

In some embodiments, the number of antenna ports of the reference signal is 1 or 2.

In some embodiments, the antenna polarization information includes single polarization or multi-polarization.

In some embodiments, the beam width information includes the number of antenna ports with a first dimension and the number of antenna ports with a second dimension.

In some embodiments, the beam direction information includes a codebook index.

In some embodiments, the codebook index corresponds to an angle of departure or an antenna emission phase.

In some embodiments, that each of the beam indications is at least used by the first module or the second module to transmit a signal and/or receive a signal refers to that the first module or the second module transmit a signal and/or receive a signal by using a spatial filter corresponding to each of the beam indications.

In some embodiments, the first to sixth beam indications are carried by dynamic signaling or semi-static signaling.

In some embodiments, the dynamic signaling is downlink control information (DCI) or a physical downlink control channel (PDCCH).

In some embodiments, the semi-static signaling is MAC CE signaling or RRC signaling.

In some embodiments, the first band is located within a first frequency range, and the second band is located within a second frequency range.

In some embodiments, the first network device and the second network device are the same or different.

In some embodiments, subcarrier spacing of the first band and subcarrier spacing of the second band are different.

In some embodiments, the first band includes a first carrier, the first carrier including a first downlink carrier and/or a first uplink carrier.

In some embodiments, the first uplink carrier and the first downlink carrier are located at the same position in the frequency domain or do not overlap in the frequency domain.

In some embodiments, the second band includes a second carrier, the second carrier including a second downlink carrier and/or a second uplink carrier.

In some embodiments, the second uplink carrier and the second downlink carrier are located at the same position in the frequency domain or do not overlap in the frequency domain.

In some embodiments, subcarrier spacing of the first downlink carrier and subcarrier spacing of the second downlink carrier are different.

In some embodiments, subcarrier spacing of the first uplink carrier and subcarrier spacing of the second uplink carrier are different.

In some embodiments, the first module 1901 further receives and/or transmits signals at the second band.

In some embodiments, the first module 1901 receives a first reference signal at the first downlink carrier and/or the second downlink carrier.

In some embodiments, the first module 1901 further transmits a measurement report of the first reference signal of the first downlink carrier and/or the second downlink carrier.

In some embodiments, the first module 1901 transmits a second reference signal at the first uplink carrier and/or the second uplink carrier.

Each of the above embodiments is only illustrative for the embodiments of the present disclosure, but the present disclosure is not limited to this, appropriate modifications may be also made based on the above each embodiment. For example, each of the above embodiments may be used individually, or one or more of the above embodiments may be combined.

In the embodiments of the present disclosure, the repeater may be a transponder, a radio frequency repeater, a radio frequency relay, a transponder node, a repeater node, a relay node, an intelligent transponder, an intelligent repeater, an intelligent relay, an intelligent transponder node, an intelligent repeater node, an intelligent relay node, etc., however the present disclosure is not limited to this, it may further be other device.

According to the device in the embodiments of the present disclosure, by obtaining a first beam indication and/or a second beam indication, communication (information interaction) between a repeater and a base station (a first network device) may be achieved. In addition, by obtaining a third beam indication and/or a fourth beam indication, forwarding of a signal between a base station (a second network device) and a terminal equipment by the repeater may be achieved.

### Embodiments of a Third Aspect

The embodiments of the present disclosure provide a communication system, the communication system including a network device, a repeater and a terminal equipment.

In the embodiments of the present disclosure, transmission of existing or further implementable services may be carried out between the network device and the terminal equipment. For example, these services may include but be not limited to: enhanced Mobile Broadband (eMBB), massive Machine Type Communication (mMTC), Ultra-Reliable Low-Latency Communication (URLLC), Internet of Vehicles (V2X) communication and so on.

In the embodiments of the present disclosure, the network device is configured to transmit signals to and/or receive signals from the repeater (NCR-MT); and/or, the network device is configured to transmit signals to the terminal equipment via the repeater (NCR-Fwd) and/or to receive signals from the terminal equipment via the repeater (NCR-Fwd); the repeater is configured to perform the method described in the embodiments of the first aspect, the contents of which are incorporated here and are not repeated here.

The embodiments of the present disclosure further provides a repeater, the repeater e.g. may be a transponder, a radio frequency repeater, a radio frequency relay, a transponder node, a repeater node, a relay node, an intelligent transponder, an intelligent repeater, an intelligent relay, an intelligent transponder node, an intelligent repeater node, an intelligent relay node, etc., however the present disclosure is not limited to this, it may further be other device.

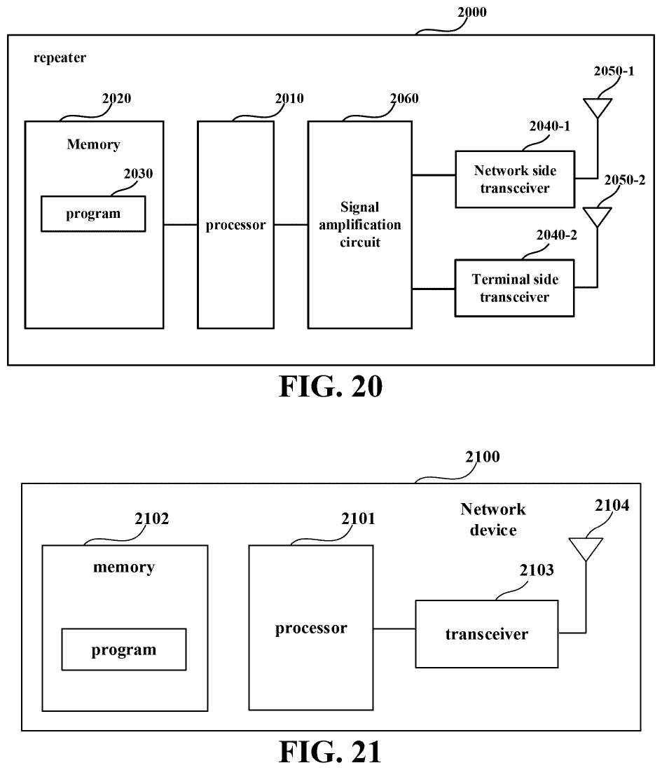

FIG. 20 is a schematic diagram of a repeater in the embodiments of the present disclosure. As shown in FIG. 20, the repeater 2000 may include a processor 2010 and a memory 2020; the memory 2020 stores data and programs 2030, and is coupled to the processor 2010. It's worth noting that this figure is exemplary; other types of structures may also be used to supplement or replace this structure, so as to realize a telecommunication function or other functions.

For example, the processor 2010 may be configured to execute a program to implement the method as described in the embodiments of the first aspect.

As shown in FIG. 20, the repeater 2000 may further include: a network side transceiver 2040-1 and a network side antenna 2050-1, a terminal side transceiver 2040-2 and a terminal side antenna 2050-2, and a signal amplification circuit 2060, etc.; the functions of said components are similar to relevant arts, which are not repeated here. It's worth noting that the repeater 2000 does not have to include all the components shown in FIG. 20. Moreover, the repeater 2000 may also include components not shown in FIG. 20, related arts may be referred to.

The embodiments of the present disclosure further provide a network device.

FIG. 21 is a schematic diagram of a network device in the embodiments of the present disclosure. As shown in FIG. 21, the network device 2100 may include: a central processing unit (CPU) 2101 and a memory 2102; the memory 2102 is coupled to the central processing unit 2101. The memory 2102 may store various data; moreover, also stores a program for information processing, and executes the program under the control of the processor 2101, so as to receive various information transmitted by the terminal equipment and transmit various information to the terminal equipment.

For example, the processor 2101 may be configured to execute a program to transmit a signal to the MT of the repeater and/or receive a signal from the MT of the repeater. Interaction between the network device and the repeater has been described in detail in each of the preceding embodiments, and is not repeated here.

In addition, as shown in FIG. 21, the network device 2100 may further include: a transceiver 2103 and an antenna 2104, etc.; wherein the functions of said components are similar to relevant arts, which are not repeated here. It's worth noting that the network device 2100 does not have to include all the components shown in FIG. 21. Moreover, the network device 2100 may also include components not shown in FIG. 21, related arts may be referred to.

The embodiments of the present disclosure further provide a network device. The network device includes a transmitting unit configured to transmit a signal to a mobile terminal of a repeater, and/or, a receiving unit configured to receive a signal from the mobile terminal of the repeater. Relevant contents of the network device have been described in detail in each of the preceding embodiments, which are incorporated here, and are not repeated here.

The embodiments of the present disclosure further provide a computer readable program, wherein when the program is executed in a repeater, the program enables a computer to execute the method as described in the embodiments of the first aspect, in the repeater.

The embodiments of the present disclosure further provide a storage medium in which a computer readable program is stored, wherein the computer readable program enables a computer to execute the method as described in the embodiments of the first aspect, in a repeater.

The device and method in the present disclosure may be realized by hardware, or may be realized by combining hardware with software. The present disclosure relates to such a computer readable program, when the program is executed by a logic component, the computer readable program enables the logic component to realize the device described in the above text or a constituent component, or enables the logic component to realize various methods or steps described in the above text. The logic component is e.g. a field programmable logic component, a microprocessor, a processor used in a computer, etc. The present disclosure also relates to a storage medium storing the program, such as a hard disk, a magnetic disk, an optical disk, a DVD, a flash memory and the like.

By combining with the method/device described in the embodiments of the present disclosure, it may be directly reflected as hardware, a software executed by a processor, or a combination of the two. For example, one or more in the functional block diagram or one or more combinations in the functional block diagram as shown in the drawings may correspond to software modules of a computer program flow, and may also correspond to hardware modules. These software modules may respectively correspond to the steps as shown in the drawings. These hardware modules may be realized by solidifying these software modules e.g. using a field-programmable gate array (FPGA).

A software module may be located in a RAM memory, a flash memory, a ROM memory, an EPROM memory, an EEPROM memory, a register, a hard disk, a mobile magnetic disk, a CD-ROM or a storage medium in any other form as known in this field. A storage medium may be coupled to a processor, thereby enabling the processor to read information from the storage medium, and to write the information into the storage medium; or the storage medium may be a constituent part of the processor. The processor and the storage medium may be located in an ASIC. The software module may be stored in a memory of a mobile terminal, and may also be stored in a memory card of the mobile terminal. For example, if a device (such as the mobile terminal) adopts a MEGA-SIM card with a larger capacity or a flash memory apparatus with a large capacity, the software module may be stored in the MEGA-SIM card or the flash memory apparatus with a large capacity.

One or more in the functional block diagram or one or more combinations in the functional block diagram as described in the drawings may be implemented as a general-purpose processor for performing the functions described in the present disclosure, a digital signal processor (DSP), an application-specific integrated circuit (ASIC), a field-programmable gate array (FPGA) or other programmable logic device, discrete gate or transistor logic device, discrete hardware components or any combination thereof. One or more in the functional block diagram or one or more combinations in the functional block diagram as described in the drawings may further be implemented as a combination of computer equipments, such as a combination of a DSP and a microprocessor, a plurality of microprocessors, one or more microprocessors combined and communicating with the DSP or any other such configuration.

The present disclosure is described by combining with the specific implementations, however persons skilled in the art should clearly know that these descriptions are exemplary and do not limit the protection scope of the present disclosure. Persons skilled in the art may make various variations and modifications to the present disclosure according to the principle of the present disclosure, these variations and modifications are also within the scope of the present disclosure.

Regarding the above implementations disclosed in this embodiment, the following supplements are further disclosed:
1. A communication method, wherein the method includes:
a first module of a repeater acquires a first beam indication, the first beam indication being at least used by the first module to receive a signal from a first network device at a first band, and/or the first module of the repeater acquires a second beam indication, the second beam indication being at least used by the first module to transmit a signal to the first network device at the first band,
and the first module acquires a third beam indication, the third beam indication being at least used by a second module of the repeater to receive a third signal from a second network device at a second band, the third signal being used to be forwarded, and/or, the first module acquires a fourth beam indication, the fourth beam indication being at least used by the second module to forward a processed fourth signal from a terminal equipment to the second network device at the second band, and
the first band and the second band do not overlap in a frequency domain.
2. The method according to Supplement 1, wherein the third beam indication is further used by the first module to receive a signal from the second network device at the second band, and/or the fourth beam indication is further used by the first module to transmit a signal to the second network device at the second band.
3. The method according to any one of Supplements 1 to 2, wherein the method further includes:
the first module further acquires a fifth beam indication, the fifth beam indication being at least used by the second module to transmit a processed third signal at the second band, and/or, the first module further acquires a sixth beam indication, the sixth beam indication being at least used by the second module to receive the fourth signal at the second band.
4. The method according to any one of Supplements 1 to 3, wherein the first to sixth beam indications at least include information related to a beam and/or a spatial filter and/or a reference signal, the information comprising at least one piece of the following information:
a spatial filter index and/or a beam index;
a reference signal index;
the number of antenna ports of a reference signal;
antenna polarization information;
beam width information; and
beam direction information.
5. The method according to Supplement 4, wherein
the number of antenna ports of the reference signal is 1 or 2.
6. The method according to any one of Supplements 4 to 5, wherein
the antenna polarization information includes single polarization or multi-polarization.
7. The method according to any one of Supplements 4 to 6, wherein
the beam width information includes the number of antenna ports with a first dimension and the number of antenna ports with a second dimension.
8. The method according to any one of Supplements 4 to 7, wherein
the beam direction information includes a codebook index.
9. The method according to any one of Supplements 4 to 8, wherein
the codebook index corresponds to an angle of departure or an antenna emission phase.
10. The method according to any one of Supplements 1 to 9, wherein that each of the beam indications is at least used by the first module or the second module to transmit a signal and/or receive a signal refers to that,
the first module or the second module transmits a signal and/or receives a signal by using spatial filters corresponding to the beam indications.
11. The method according to any one of Supplements 1 to 10, wherein the first to sixth beam indications are carried by dynamic signaling or semi-static signaling.
12. The method according to Supplement 11, wherein the dynamic signaling is downlink control information (DCI) or a physical downlink control channel (PDCCH).
13. The method according to any one of Supplements 11 to 12, wherein the semi-static signaling is MAC CE signaling or RRC signaling.
14. The method according to any one of Supplements 1 to 13, wherein the first band is located within a first frequency range, and the second band is located within a second frequency range.
15. The method according to any one of Supplements 1 to 14, wherein the first network device and the second network device are the same or different.
16. The method according to any one of Supplements 1 to 15, wherein subcarrier spacing of the first band and subcarrier spacing of the second band are different.
17. The method according to any one of Supplements 1 to 16, wherein the first band comprises a first carrier, the first carrier comprising a first downlink carrier and/or a first uplink carrier.
18. The method according to Supplement 17, wherein the first uplink carrier and the first downlink carrier are located at the same position in the frequency domain or do not overlap in the frequency domain.
19. The method according to any one of Supplements 1 to 18, wherein the second band comprises a second carrier, the second carrier comprising a second downlink carrier and/or a second uplink carrier.
20. The method according to Supplement 19, wherein the second uplink carrier and the second downlink carrier are located at the same position in the frequency domain or do not overlap in the frequency domain.
21. The method according to any one of Supplements 17 to 20, wherein subcarrier spacing of the first downlink carrier and subcarrier spacing of the second downlink carrier are different.
22. The method according to any one of Supplements 17 to 21, wherein subcarrier spacing of the first uplink carrier and subcarrier spacing of the second uplink carrier are different.
23. The method according to any one of Supplements 1 to 22, wherein the method further includes:
the first module receives and/or transmits a signal at the second band.
24. The method according to any one of Supplements 17 to 23, wherein the method further comprises:
the first module receives a first reference signal at the first downlink carrier and/or the second downlink carrier.
25. The method according to any one of Supplements 17 to 24, wherein the method further includes:
the first module transmits a measurement report of the first reference signal of the first downlink carrier and/or the second downlink carrier.
26. The method according to any one of Supplements 17 to 25, wherein the method further includes:
the first module transmits a second reference signal at the first uplink carrier and/or the second uplink carrier.
27. A repeater, comprising a memory and a processor, the memory storing a computer program, and the processor being configured to execute the computer program to achieve the method according to any one of Supplements 1 to 26.
28. A network device, comprising a memory and a processor, the memory storing a computer program, and the processor being configured to execute the computer program to transmit signals to the MT of the repeater and/or receive signals from the MT of the repeater.
29. A communication system, comprising a network device, a terminal equipment and a repeater, wherein,
the network device is configured to transmit a signal to the repeater (NCR-MT) and/or receive a signal from the repeater (NCR-MT); and/or the network device is configured to transmit a signal to the terminal equipment via the repeater (NCR-Fwd) and/or receive a signal from the terminal equipment via the repeater (NCR-Fwd);
the repeater is configured to perform the method according to any one of Supplements 1 to 26.

What is claimed is:

1. A communication device, comprising:
a first module of a repeater acquires a first beam indication, the first beam indication being at least used by the first module to receive a signal from a first network device at a first band, and/or the first module of the repeater acquires a second beam indication, the second beam indication being at least used by the first module to transmit a signal to the first network device at the first band,
and the first module acquires a third beam indication, the third beam indication being at least used by a second module of the repeater to receive a third signal from a second network device at a second band, the third signal being used to be forwarded, and/or, the first module acquires a fourth beam indication, the fourth beam indication being at least used by the second module to forward a processed fourth signal from a terminal equipment to the second network device at the second band, and
the first band and the second band do not overlap in a frequency domain.

2. The device according to claim 1, wherein the third beam indication is further used by the first module to receive a signal from the second network device at the second band, and/or the fourth beam indication is further used by the first module to transmit a signal to the second network device at the second band.

3. The device according to claim 1, wherein,
the first module further acquires a fifth beam indication, the fifth beam indication being at least used by the second module to transmit a processed third signal at the second band, and/or, the first module further acquires a sixth beam indication, the sixth beam indication being at least used by the second module to receive the fourth signal at the second band.

4. The device according to claim 1, wherein the first to fourth beam indications at least include information related to a beam and/or a spatial filter and/or a reference signal, the information comprising at least one piece of the following information:
a spatial filter index and/or a beam index;
a reference signal index;
the number of antenna ports of a reference signal;
antenna polarization information;
beam width information; and
beam direction information.

5. The device according to claim 1, wherein that each of the beam indications is at least used by the first module or the second module to transmit a signal and/or receive a signal refers to that,
the first module or the second module transmits a signal and/or receives a signal by using spatial filters corresponding to the beam indications.

6. The device according to claim 1, wherein the first to fourth beam indications are carried by dynamic signaling or semi-static signaling.

7. The device according to claim 6, wherein the dynamic signaling is downlink control information DCI or a physical downlink control channel PDCCH.

8. The device according to claim 6, wherein the semi-static signaling is MAC CE signaling or RRC signaling.

9. The device according to claim 1, wherein subcarrier spacing of the first band and subcarrier spacing of a second band are different.

10. The device according to claim 1, wherein the first band comprises a first carrier, the first carrier comprising a first downlink carrier and/or a first uplink carrier.

11. The device according to claim 10, wherein the first uplink carrier and the first downlink carrier are located at the same position in the frequency domain or do not overlap in the frequency domain.

12. The device according to claim 1, wherein the second band comprises a second carrier, the second carrier comprising a second downlink carrier and/or a second uplink carrier.

13. The device according to claim 12, wherein the second uplink carrier and the second downlink carrier are located at the same position in the frequency domain or do not overlap in the frequency domain.

14. The device according to claim 10, wherein subcarrier spacing of the first downlink carrier and subcarrier spacing of a second downlink carrier are different.

15. The device according to claim 1, wherein,
the first module receives and/or transmits a signal at the second band.

16. The device according to claim 10, wherein,
the first module receives a first reference signal at the first downlink carrier and/or the second downlink carrier.

17. The device according to claim 16, wherein,
the first module transmits a measurement report of the first reference signal of the first downlink carrier and/or the second downlink carrier.

18. The device according to claim 10, wherein,
the first module transmits a second reference signal at the first uplink carrier and/or the second uplink carrier.

19. A network device, comprising:
a transmitter configured to transmit a signal to a mobile terminal of a repeater, and/or,
a receiver configured to receive a signal from the mobile terminal of the repeater.

20. A communication system, comprising a network device, a terminal equipment and a repeater, wherein,
the network device is configured to transmit a signal to and/or receive a signal from the repeater, and/or the network device is configured to transmit a signal to the terminal equipment via the repeater and/or receive a signal from the terminal equipment via the repeater;
and the repeater is configured to:
acquire a first beam indication via a first module, the first beam indication being at least used by the first module to receive a signal from a first network device at a first band, and/or, acquire a second beam indication via the first module, the second beam indication being at least used by the first module to transmit a signal to the first network device at the first band,
and acquire a third beam indication via the first module, the third beam indication being at least used by a second module to receive a third signal from a second network device at a second band, the third signal being used to be forwarded, and/or, acquire a fourth beam indication via the first module, the fourth beam indication being at least used by the second module to forward a processed fourth signal from a terminal equipment to the second network device at the second band, and
the first band and the second band do not overlap in a frequency domain.
